(19) United States
(12) Patent Application Publication
(10) Pub. No.: US 2010/0013115 A1
(43) Pub. Date: Jan. 21, 2010

(54) Apparatus and Method for Forming Fibers

(76) Inventors: David N. Breslauer, Oakland, CA (US); Luke P. Lee, Orinda, CA (US)

Correspondence Address: GORDON & REES LLP, 101 WEST BROADWAY, SUITE 1600, SAN DIEGO, CA, 92101, US

(21) Appl. No.: 12/303,544

(22) PCT Filed: Jun. 5, 2007
(86) PCT No.: PCT/US07/13311

§ 371 Date: Jul. 16, 2009

Related U.S. Application Data
(60) Provisional application No. 60/811,342, filed on Jun. 6, 2006.

(51) Int. Cl. B29C 47/94

(52) U.S. Cl. 264/130; 425/95

(57) ABSTRACT

A method and apparatus for forming materials such as fiber and elongated shapes, including: a tapered flow channel; supply channels for the addition and removal of agents into the tapered flow channel; and a fiber outlet at the distal end of the tapering flow channel.

### CROSS REFERENCE TO RELATED APPLICATIONS

This application claims priority from International Patent Application Number PCT/US2007/013311 filed on 6 Jun. 2007 which claims priority from a U.S. Provisional Application Ser. No 60/811,342 filed on 6 Jun. 2006.

### TECHNICAL FIELD

The present invention relates to systems and methods for forming fibers and other elongated materials that are often used in textiles, manufacturing, and other fields, from liquid solutions, such as polymer solutions.

### BACKGROUND OF THE INVENTION

Fibers, filaments, and threads are of tremendous commercial interest and thus it is desirable to develop improved methods of forming these types of materials.

Natural silkworm silk fibers have been used for centuries in clothing, as medical sutures, fishing nets, and for many other applications. Silkworms are easily cultivated in order to obtain high quantities of silk fiber. Spiders and other arachnids also naturally produce silk fibers, of which the primary dragline silk is of specific interest. The dragline silk of many spiders has toughness greater than many man-made fibers, is times stronger by weight than steel, and has comparable tensile strength to Kevlar.

Unlike silkworm silk, the inability to domesticate spiders due to their carnivorous and territorial nature has made it difficult to cultivate bulk quantities of spider silk fibers. Therefore, it would be desirable to devise a system or machine that could produce spider silk-type fibers.

In this regard, both the chemical composition and genetic bases of many spider silk proteins have been established. However, the exact mechanism of spinning silk has yet to be fully elucidated or copied. Despite the inefficient translation of the silk protein due to its unusual RNA secondary structure, recombinant silk protein has been generated in bacteria, yeast, and mammalian cells. However, the recombinant silk is not identical to that produced by the spider, because of the genetic manipulation necessary to translate the unusual RNA in transgenic systems.

Regardless of whether using recombinant silk, or silk protein removed directly from a spider or silkworm, spinning technology has yet to fully produce silk fibers with identical mechanical properties to those produced by the organisms themselves.

Instead, the following three techniques are most often used to produce polymers fibers, including silk fibers: (1) “Melt spinning” in which the polymer compound is melted at high temperatures, and the melt is extruded through a spinneret; (2) “Wet spinning” in which the polymer compound is dissolved in a highly reactive solvent, and the solution is extruded through a spinneret while submerged in liquid that diffuses throughout the solvent or reacts with the fiber; and (3) “Dry spinning” in which the polymer compound is dissolved in a highly reactive solvent, and the solution is extruded through a spinneret at high temperature such that the solvent evaporates. (4) “Electrospinning” is in which a polymer is dissolved in a highly reactive solvent and slowly ejected from a nozzle and a strong electric field (˜30 kV) is applied between the nozzle and a collector plate, which charges to the polymer and pulls it on to the plate.

Unfortunately, none of the above methods have been effective at spinning silk fibers with the same properties as produced by a spider in vivo. Unfortunately as well, the extreme conditions currently required for spinning synthetic silks potentially damage the polymer proteins. Spiders, on the other hand, spin their recyclable silk fibers at ambient temperatures, low pressure, and using water as a solvent. Spiders take advantage of precision geometries and complex chemistries in order to engineer fibers. The present invention is inspired by these mechanisms, and comprises a novel apparatus that can be used for forming fibers and other materials, such as silk fibers.

### SUMMARY OF THE INVENTION

The present invention provides a method and apparatus for forming fibers and elongated materials from a liquid “spinning” solution, such as a polymer solution. In its various embodiments, the present invention also provides a system for producing artificial spider web-type fibers. In one aspect, the present invention provides a microfluidic device for micro- and nano-fiber formation that directly mimics the complexity of in vivo arachnid silk spinning organs.

Different embodiments of the present invention are described herein. A first embodiment comprises a reservoir; a tapering flow channel extending away from the reservoir; a coating injector disposed between the reservoir and a proximal end of the tapering flow channel; a gradient generator connected to the tapering flow channel; a fluid outlet at a distal end of the tapering flow channel; and a fiber outlet at the distal end of the tapering flow channel. In one aspect, the coating injector is disposed to inject coating into the flow path from the reservoir into the tapering flow channel. Preferably, this coating is a lipid lubricating layer that decreases wall shear felt by the solution passing out of the reservoir.

A second embodiment comprises a reservoir; a tapering flow channel extending away from the reservoir; at least one supply channel; and a series of feeder channels connecting the at least one supply channel to the tapering flow channel, wherein the series of feeder channels are dimensioned to generate a gradient in a fluid passing along through the length of the tapering flow channel. In this preferred aspect, the present apparatus comprises an extrusion channel (i.e.: tapering flow channel) through which the liquid spinning solution flows and forms into a fiber, or other elongated material. The supply and feeder channels allow mass transport to and from the liquid solution in the tapering flow channel.

In this second embodiment, the series of feeder channels may be dimensioned such that particle movement from the at least one supply channel to the tapering flow channel is dominated by diffusion effects rather than by convection effects. To achieve this effect, the at least one supply channel, the series of feeder channels, and the tapering flow channel may have relative dimensions such that fluidic resistance in the series of feeder channels is at least an order of magnitude higher than the fluidic resistance in either the at least one supply channel, or the tapering flow channel. The tapering flow channel may optionally be shaped as a hyperbolically converging tube, but the present invention is not limited to this geometry. A fiber outlet may be provided at the distal end of tapered flow channel. This fiber outlet may optionally have a diameter from 1 micrometer to 10 millimeters. It is to be understood, however, that these dimensions are only exemplary and the present invention is not limited to these dimensions.

In the second embodiment, a fluid comprising a buffer or an ionic solution can be passed along through the at least one supply channel. Alternately, a gas can be passed along through the at least one supply channel. Optionally, two or more supply channels may be provided, and the same (or different) substances can be passed along through these individual supply channels. It is to be understood that any number of supply channels may be used, and that the present invention is not limited to any particular number of supply flow channels.

Either of the above two embodiments of the present invention may optionally be formed from a unitary block of material, such as polydimethylsiloxane (PDMS).

In its various embodiments, the system may optionally generate an increasing gradient of potassium ions along the flow path, a decreasing gradient of sodium ions along the flow path; and/or a decreasing pH gradient along the flow path.

Optionally, a fiber diameter adjustment valve may be positioned at the fiber outlet. In one aspect, the fiber diameter adjustment valve may simply comprise a deformable elastomeric section of the tapering flow channel. A pressure channel to move the deformable elastomeric membrane may also be included.

A unique advantage of the second embodiment of the invention is that it provides a very simple and efficient system for generating gradients along the flow path. For example, the feeder channels may be sized such that their fluidic resistance is at least an order of magnitude larger than the fluidic resistance of the extrusion channel (i.e.: tapered flow channel) and supply flow channels. In this way, the feeder channels have a large enough fluidic resistance such that mass transport through them is diffusion dominated, rather than convection dominated. The series of feeder channels thus acts similarly to a porous membrane surrounding the tapering flow channel, allowing diffusion-based mass transport into and out of the tapering flow channel and the liquid polymer solution therein from the supply flow channels.

The ability to introduce and remove components of the liquid solution through the supply and feeder channels during extrusion (i.e. material formation) enables precise control of the formation process and the resulting material. Properties of the liquid solution that are relevant for the material formation process and the properties of the resulting material can be controlled. By example only, the supply flow channels can contain a flow of gas to concentrate the liquid solution by evaporation, a buffer in order to control the pH of the liquid solution, and/or ionic solutions to regulate the ionic composition of the liquid spinning solution. Other examples include the introduction of crosslinking agents and lubricants.

Preferably, the supply channels contain liquids, gases, and/or varied temperature solutions. Preferably, flow in the supply channels is fast enough such that the concentration inside is essentially constant. It will be appreciated that potentially interesting and useful composition gradients can be created along the extrusion channel by using different flow rates and agents in the supply flow channels.

One or more supply channels can be connected to the extrusion channel. The supply channels can be of any shape or size. Each supply channel can carry the same or a different supply agent. It will be appreciated that different sides of the extrusion channel can be treated differently by flowing different agents in the supply flow channels.

Advantages of the present invention include the fact that it can be manufactured by injection molding, soft lithography, or by other means commonly known to a craftsman skilled at the art. Optionally, the present apparatus can be fabricated as channels within a unitary piece of material, or multiple pieces of material, by a craftsman skilled at the art. The apparatus can also be manufactured from interconnected pipes, or tubes, by a craftsman skilled at the art.

In addition, the present apparatus can be arranged close to one or more similar apparatuses such that multiple materials can be formed simultaneously. In addition, as they are being formed, materials from individual apparatuses can be twisted together or otherwise combined to form novel composite materials.

In addition, the present system has a low cost of manufacture and ease of utilization, and will thus have an extraordinary impact on the medical, textile, silk, and polymer fiber industries.

Moreover, silk fibers that may be produced by the present invention can include fibers that are not rejected by the human body. As such, these fibers may be used in tissue engineering scaffolds, artificial muscles, and in wound dressings.

In addition, the present invention advantageously provides the ability to control the structure and properties of localized areas over the fiber length, as well as enable the creation of novel synthetic fibers.

In addition, the present system operates at ambient temperatures and pressures, and with no electric field. In contrast, pre-existing methods of fiber formation involve high temperatures and potent solvents in order to solubilize solid protein, as well as extremely high pressures and voltages to extrude polymers and create fibers.

In addition, as will be explained, fluid flow in the present system is generally laminar and therefore molecular diffusion can be predictably controlled. These properties enable the creation of unique devices using simple microfluidic geometries. For example, laminar flow allows barrier-free adjacent perfusion of different reagents while controlled diffusion and laminar flow in combination can be used to construct complex chemical gradients with sub-micron resolution.

In addition, as a consequence of the high degree of control over polymerization inherent in the biomimetic microfluidic fiber spinning system, the device acts as an experimental platform for the study of polymer physics. As a result, regulated polymerization and crystallization can be dynamically observed and studied under selective treatment of fiber areas for advanced research into the physicochemical dynamics of protein polymerization.

### BRIEF DESCRIPTION OF THE DRAWINGS

FIG. 1 is a top plan view of a first embodiment of the present system (for example, as formed into a top surface of an integral block of material, such as PDMS).

FIG. 2 is a close-up top plan illustration of the coating injector of FIG. 1.

FIG. 3 is an illustration of the gradient generator portion of the system of FIG. 1 (showing three different gradient changes).

FIG. 4 is an illustration of fluid flow through the tapered flow channel of the system shown in FIG. 1.

FIG. 5 corresponds to FIG. 4, but illustrates the shear-induced polymerization of the polymer solution occurring in the tapered flow channel.

FIG. 6 is a close-up top plan view of an optional mechanical valve for adjusting the resulting fiber diameter.

FIG. 7 is a close-up top plan view of the optional system for removing solvent from the resulting fiber.

FIG. 8 is a perspective view of a second embodiment of the present invention having two supply channels and a series of feeder channels connecting the two supply channels to the tapering flow channel.

FIG. 9 is a cross-sectional view corresponding to FIG. 8. This embodiment of the invention may optionally be formed into an integral block of material, such as polydimethylsiloxane (PDMS).

FIG. 10 is a sectional elevation view of an embodiment of the invention similar to FIGS. 8 and 9, but having four supply channels. This embodiment of the invention may optionally be formed into an integral block of material, such as polydimethylsiloxane (PDMS) as well.

### DETAILED DESCRIPTION OF THE DRAWINGS

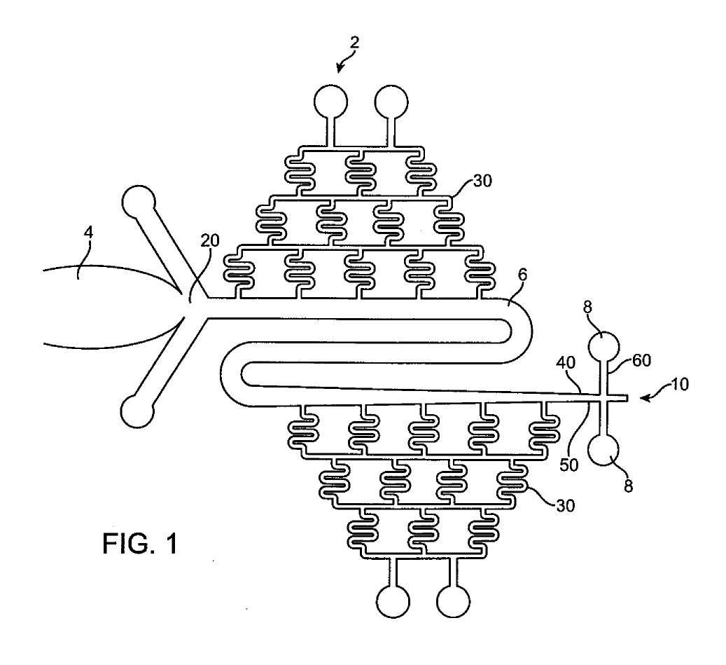

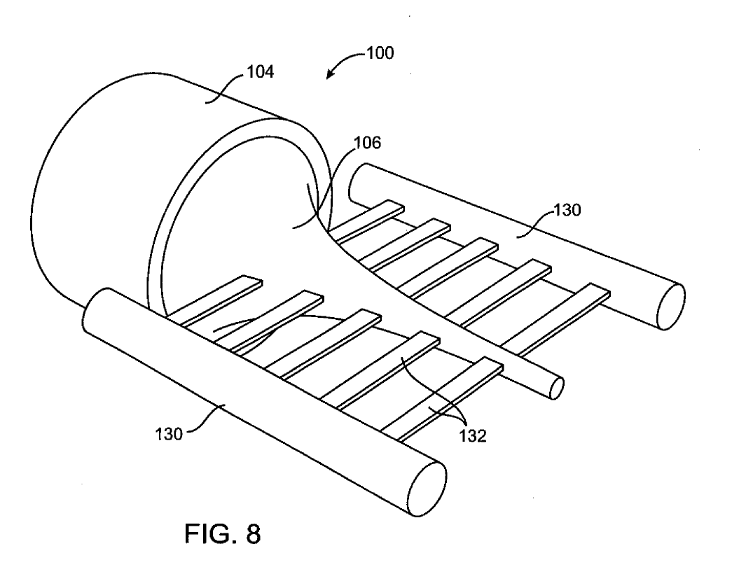

FIGS. 1 to 7 illustrate a first embodiment of the present invention, and will be described first below. FIGS. 8 to 10 illustrate a second embodiment of the present invention. However, many of the concepts disclosed in FIGS. 1 to 7 also apply to the operation of the second embodiment of the invention seen in FIGS. 8 to 10, as will be explained.

Turning to the first embodiment seen in FIGS. 1 to 7, the present system operates as follows. First a polymer solution passes into the device from a reservoir, and additional fluidic inlets allow a lipid coat to be introduced as a laminar sheath flow. The solution then flows through a channel with a chemical gradient generators and a gradual taper that causes shear and/or elongation-induced polymerization. Lastly, a pressure-controlled membrane allows fine-tuning of the fiber diameter, and fluidic outlets allow excess water to escape the device just before the fiber itself exits.

More specifically, the present invention provides a novel system for producing micro- and nano-fibers, as follows. As seen in FIG. 1, system 2 comprises: a reservoir 4 and a tapering flow channel 6 extending away from reservoir 4. A coating injector 20 is disposed between reservoir 4 and a proximal end of tapering flow channel 6. A gradient generator 30 is connected to tapering flow channel 6. A fluid outlet 8 is disposed at a distal end of tapering flow channel 6, and a fiber outlet 10 is also disposed at the distal end of tapering flow channel 6. FIG. 1 is a two-dimensional view of fluidic channels fabricated in a substrate. In various preferred embodiments, the largest channels are on the width order of approximately 200 microns. In various embodiments of the present invention, the polymer preferably flows as a steady stream throughout the flow path. However, it is to be understood that the present invention encompasses all types of flow including intermittent polymer flow. As such, an optional polymer flow droplet generator (not illustrated) may be provided for passing a polymer flow into reservoir 4.

In operation, the solvent (e.g.: water) and polymer solution (e.g.: protein) are immiscible. Thus, the shear caused by the solvent flow competes with the surface tension of the polymer solution. Depending on the fluid flow rates, at regular intervals, uniform droplets of polymer solution will pinch off the polymer solution stream into the larger chamber. This allows controlled solution quenching, i.e. regulation of the amount of solvent adsorbed by the polymer droplets by controlling the rate at which droplets are formed. In preferred embodiments, the polymer solution can be pre-treated with solvent such that an optional shear focusing polymer droplet generator is not required.

In various exemplary uses of the present invention, fibers having dimensions on the order of 100 nanometers to 1 millimeter in diameter can be produced. It is to be understood, however, that other fiber diameters are possible, all keeping within the scope of the present invention.

In optional embodiments, system 2 can be entirely formed into the top surface of a unitary block of material, such as PDMS. Alternately, however, the present system 2 can be formed from more than one block of material. In addition, tapered channel 6 can optionally be formed to be cylindrical in shape.

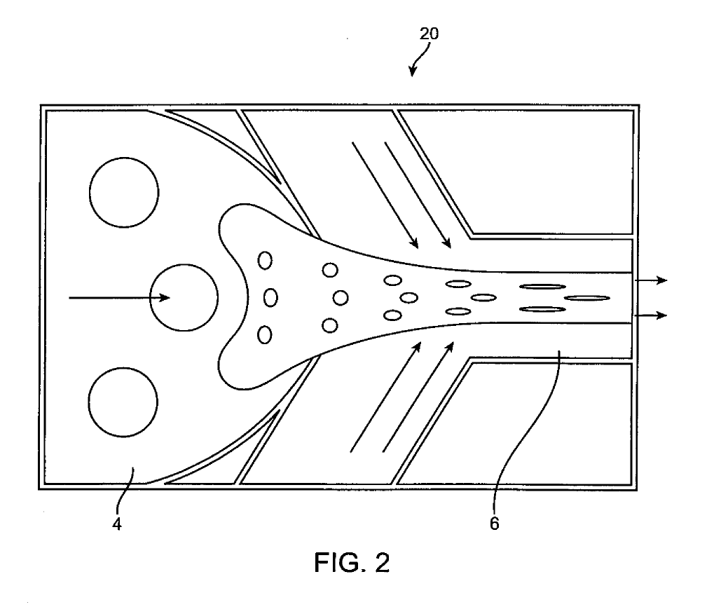

Coating injector 20 (see detail in FIG. 2) is configured to inject a lubricating layer that decreases shear felt by the solution passing out of reservoir 4. Coasting injector 20 is preferably disposed to inject coating into the downstream flow path from reservoir 4 into tapering flow channel 6. As illustrated, coating injector 20 may comprise a pair of injectors, each angled at about 45 degrees to the flow path. It is to be understood, however, that this particular angle is only exemplary, and that other angles and embodiments may be used, all keeping within the scope of the present invention.

In operation, coating injector 20 serves two functions. As the droplets come in close proximity to each other as the channel narrows, they will coalesce and form a fluid stream. As this stream flows through tapered channel 6, the polymer molecules begin to align along the direction of flow. This allows for the control of the mechanical properties of the produced fibers. In addition, coating injector 20's fluidic inlets allow an extra layer of fluid to be introduced laminarly over the polymer solution stream. Because of the small scale of microfluidic flow, this solution will flow adjacently to the polymer solution with mixing only by diffusion. This optional “extra coat” can, for example, be a lubricating layer, an additional polymer solution, or a crystallization-inducing substance.

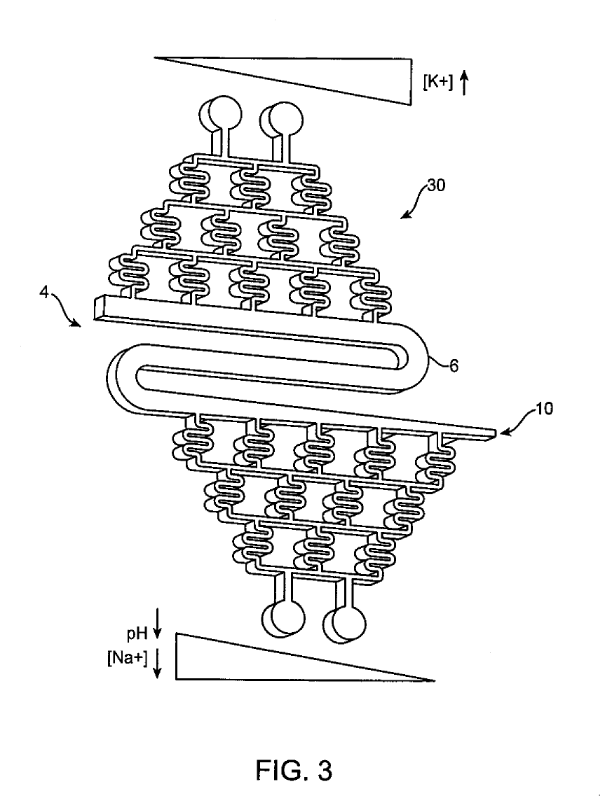

Gradient generator 30 (see detail in FIG. 3) is configured to form a chemical gradient along the length of fiber-forming tapered channel 6. In accordance with the present invention, such fiber chemical baths cause protein refolding/polymerization and remodeling, which determines the fiber mechanical properties.

In one embodiment, gradient generator 30 generates an increasing gradient of potassium ions [K+] downstream along the flow path. In another embodiment, gradient generator 30 generates a decreasing gradient of sodium ions [Na+] downstream along the flow path. In yet another embodiment, gradient generator 30 generates a decreasing pH gradient along the flow path. It is to be understood that these three different gradients are merely exemplary and that other gradients can instead be generated, and that different gradients can be combined. In further alternate embodiments, gradients can also be created by pairs of electrodes positioned along the length of tapering flow channel 6. As illustrated, gradient generator 30 may comprise a serpentine network of channels, with input streams being flowed adjacently until they mix diffusively. This system will apply fine resolution chemical gradients over the protein solution flowing there past.

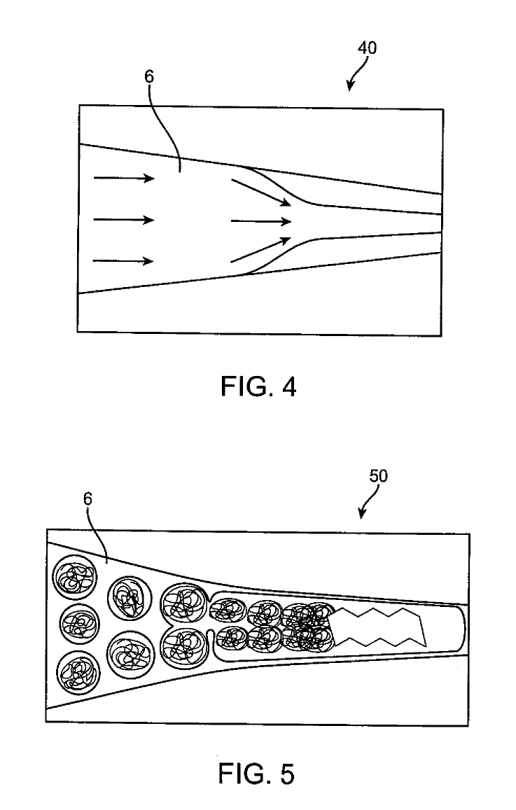

FIGS. 4 and 5 further illustrate the shear and/or elongation induced polymerization occurring in tapered flow channel 6, as follows. As the channel in which the polymer solution tapers, two different events occur simultaneously. First, solvent begins to diffuse out of the polymer solution. Second, the polymer molecules develop an ordered arrangement and polymerize with each other. Specifically, the shear stress and elongation flow from the taper causes aggregation of the polymer molecules and conformational changes, which causes the randomly oriented polymer molecules to align and polymerize into ordered structures, such as β-sheets (see FIG. 5). Depending on the velocity of the polymer solution and the shear and elongation forces it experiences, the time point at which crystallization occurs varies. Depending on the taper slope and length, a force balance can be achieved such that crystallization induction and solvent content can be precisely controlled. In the present innovative system, solvent can advantageously be removed without disturbing the flow of polymer solution in a microchannel. As solvent is removed, the polymer solution becomes more concentrated furthering crystallization.

As depicted, the tapered flow design causes concentration of the polymer solution and solvent removal. A two dimensional image is shown in FIGS. 4 and 5, however, in actuality the three-dimensional channel will be cylindrical in order to have even pressure distribution over the polymerizing molecules.

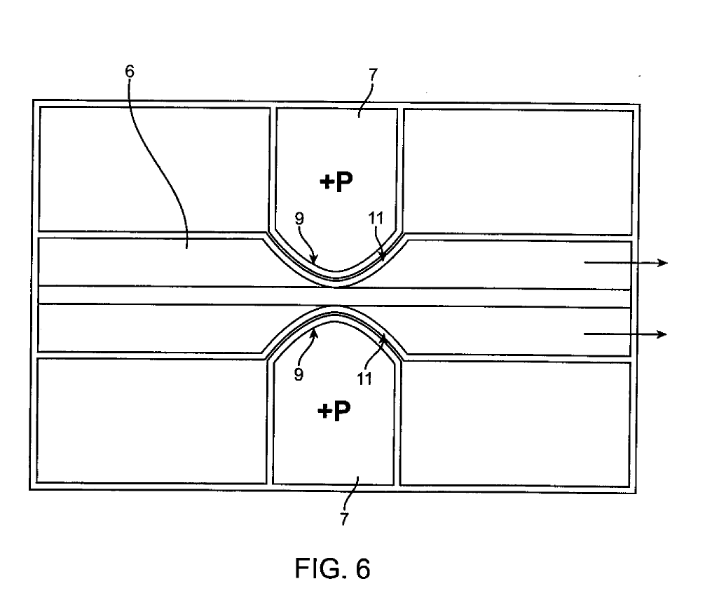

Optionally, the present invention also comprises a fiber diameter adjustment valve 7 (seen in FIG. 6) positioned at or near the fiber outlet 10. In one exemplary embodiment, fiber diameter adjustment valve 7 comprises a deformable elastomeric section 9 of tapering flow channel 6. As seen, deformable elastomeric section 9 of tapering flow channel 6 may comprise: a pressure channel 7; and a deformable elastomeric membrane 11 separating pressure channel 7 from tapering flow channel 6. Valve 7 allows fine-tuning of the fiber diameter as fibers are being formed, through mechanical compression. Valve 7 also allows for gripping fibers and reinitiating spinning if a fiber breaks. Optionally, the applied pressure can be varied dynamically in order to create fibers with different diameters along its length.

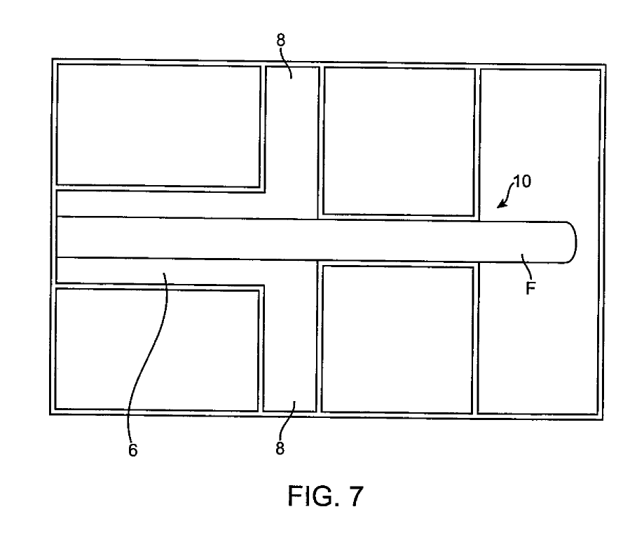

In accordance with the present invention, the solvent that diffuses out of the forming fiber can be removed so that it is not reabsorbed, affecting the fiber strength. As seen in detail in FIG. 7, optional fluidic outlets 8 may be formed through which the excess solvent can leave system 2, with a channel 13 that acts as a spigot for fiber F.

Alternatively, methods such as evaporation through the device substrate or the integration of a semipermeable membrane to filter out solvent can be used as a means of removing the excess solvent.

The present invention also provides a novel method for producing fibers, by: forming protein droplets in reservoir 4; forming a coating on a stream of the protein droplets by introducing a coating as a laminar sheath flow (with coating injector 20); passing the coated protein droplets through tapered flow path 6 while varying the chemical gradient (with gradient generator 30) along tapered flow path 6 so as to initiate polymerization and cause shear-induced polymerization and outward diffusion of solvent, thereby forming a fiber. Finally, fluid is removed at a distal end 10 of tapering flow channel 6; thereby producing fiber out of the distal end 10 of tapering flow channel 6.

Preferably, reservoir 4 is a water bath, and the coating in coating injector 20 is a lipid coating. It is to be understood, however, that the present invention is not so limited, as other fluids and coatings may also be used.

The chemical gradient can be varied along the tapered flow path by one or more of: increasing the gradient of potassium ions along the flow path; decreasing the gradient of sodium ions along the flow path; or decreasing the pH gradient along the flow path.

Optionally, the diameter of the fiber can be adjusted by adjusting the diameter of the distal end 10 of tapering flow channel 6; for example by deforming an elastomeric section 11 of tapering flow channel 6. This may be done by varying the pressure in pressure channel 7, wherein the elastomeric section 11 of tapering flow channel 6 separates pressure channel 7 from tapering flow channel 6.

FIGS. 8 to 10 show a second embodiment of the present invention, as follows. System 100 comprises a reservoir 104; a tapering flow channel 106 extending away from reservoir 104; and a pair of supply channels 130. A series of feeder channels 132 connect supply channels 130 to tapering flow channel 106.

In this second embodiment of the invention, reservoir 104 operates similar to reservoir 4 in FIG. 1. Similarly, tapering flow channel 106 operates similar to tapering flow channel 6 in FIG. 1. In this second embodiment, the series of feeder channels 132 are dimensioned such that they operate similar to gradient generator 30 in FIG. 1, as follows.

Feeder channels 132 are dimensioned to generate a gradient in the fluid passing along through the length of tapering flow channel 106. This is due to the fact that feeder channels 132 are dimensioned such that particle movement from supply channels 130 into tapering flow channel 106 is dominated by diffusion effects rather than by convection effects. This may preferably be accomplished by dimensioning the system such that the fluidic resistance in the series of feeder channels 132 is at least an order of magnitude higher than in both the fluidic resistances in the supply channels 130, and in tapering flow channel 106.

The second embodiment of the invention set forth in FIGS. 8 to 10 thus uses channel geometries to produce a gradient generator type effect along the flow path through tapering channel 106. Preferably, the fluid passing along through the length of tapering flow channel 106 comprises a protein polymer stream (exhibiting the same characteristics as was described with respect to the polymer stream passing through tapering flow channel 6).

In further optional embodiments, additional fluidic inlets (not shown) may be used to locally treat the fiber during formation. For example, an acidic buffer can be added to create local β-sheet enriched areas. With microfabrication and soft lithography techniques, channels can be created that localize fluid flow over a 2-micron length of fiber. In addition, by pulsing reagents onto the fiber at a specific frequency relative to the fiber drawing velocity, regular intervals of amorphous areas can be introduced on to the fiber. The ability to precisely regulate the ordered and amorphous β-sheet stack areas of the fiber invites new possibilities for the design of synthetic fibers with advanced mechanical properties. During these localized treatments, the dynamics of polymer crystallization can be observed using advanced Raman spectroscopy. Raman spectroscopy allows label-free and dynamic measurement of protein structure. Through the introduction of metallic nano-particles in the device, the Raman spectra throughout the polymerization and post-polymerization modification process can be studied. In combination with selective perturbation of the polymer crystallization process, new discoveries can be made about the nature of polymer physics and chemistry.

Moreover, the laminar flow that occurs at the microscale allows several streams to flow adjacently with only diffusive mixing. Therefore, sheath flows can be introduced over core flows such that layered fibers can be created. Silk can be introduced as a core fiber for strength, with a collagen fiber sheath over it for bioactivity. Other natural extracellular matrix proteins can be tested as well. Such application-specific fibers are easily manufacturable by the present system. By combining multiple microfluidic spinnerets on a translational stage, fibrous mats composed of multiple different custom fibers can be formed. Using this technique, tissue engineering scaffolds can be developed with highly specific combinations of different fibers, high strength tissue engineering scaffolds with bio-functionalized silk, and biologically active bandages that promote enhanced wound healing.

Feeder channels 132 can be of any shape and size, so long as their fluidic resistance is large enough to maintain diffusion dominated mass transport within them during normal operation of the apparatus. By altering the size of feeder channels 132, the mass flux from the supply to the tapered flow channel 106 can be altered as needed. Any number of feeder channels 132 can connect tapering flow channel 106 and supply channel(s) 130, depending on the amount of mass flux desired into or out of tapering flow channel 106. In optional embodiments, multiple feeder channels 132 can spaced out along the length or height of tapering flow channel 106, or both.

It will be appreciated that by having multiple feeder channels 132 along the length of tapering flow channel 106, a concentration gradient will naturally form along tapering flow channel 106. In addition, varying the spacing between feeder channels 132 and between individual pairs of feeder channels 132 will alter the shape of this gradient.

As can be seen, tapering flow channel 106 has a tapered shape, such that the size of the outlet is smaller that the size of the inlet. The shape of the taper can follow any function, for example, that of a hyperbolically converging tube. The shape of the channel controls the velocity field of the liquid spinning solution, and its rate of elongation. Elongational flow fields are known to stretch or extend molecules, and the present apparatus could preferably have a hyperbolic geometry that causes an increasing strain rate in the liquid spinning solution.

Tapering flow channel 106 can be any length, but preferably is long enough such that the residence time of the spinning solution (and its respective polymer molecules) in the velocity field is long for full extension and/or alignment of said molecules. In addition, tapering flow channel 106 can optionally be composed of a combination of smaller extrusion (i.e.: tapering flow) channels with the same or different shapes in order to preferentially control the spinning conditions, and other fluidic forces, along the length of the apparatus.

The cross-section of tapering flow channel 106 can take any shape such as square, rectangular, or preferably circular, depending on the cross-sectional shape desired for the formed material. In addition, tapering flow channel 106 can either be axisymmetric or asymmetric for the formation of materials axisymmetric or asymmetric shape/mechanical properties, respectively.

Additional inlets (not shown) can be included in the apparatus. Such additional inlets can be connected to tapering flow channel 106 to add an additional layer of liquid over the spinning solution. These channels can be located at any point along the length of the extrusion channel. By example only, the additional liquid layer could be a lubricant to ease the flow of spinning solution through the extrusion channel, a cross linking agent in order to begin solidification of the spinning solution, or an additional spinning solution to create a layered material.

Tapering flow channel 106 can be constructed at any scale necessary to exert the necessary conditions (such as fluidic forces) on the liquid spinning material in order to convert it into the desired material. Typically, in order to form elongated materials with diameters/widths from 100 nanometers to 1 millimeter, the exit size of the extrusion channel would preferably on the order of 1 micrometer to 10 millimeters. It will be appreciated, however, that the formed material could be larger or smaller in relevant width than the outlet of the apparatus, depending on the particular conditions under which is it formed.

In various embodiments, the liquid spinning solution (e.g.: polymer protein) can either be pushed through the apparatus (pressure-driven flow) pulled out as a formed material, or a combination thereof.

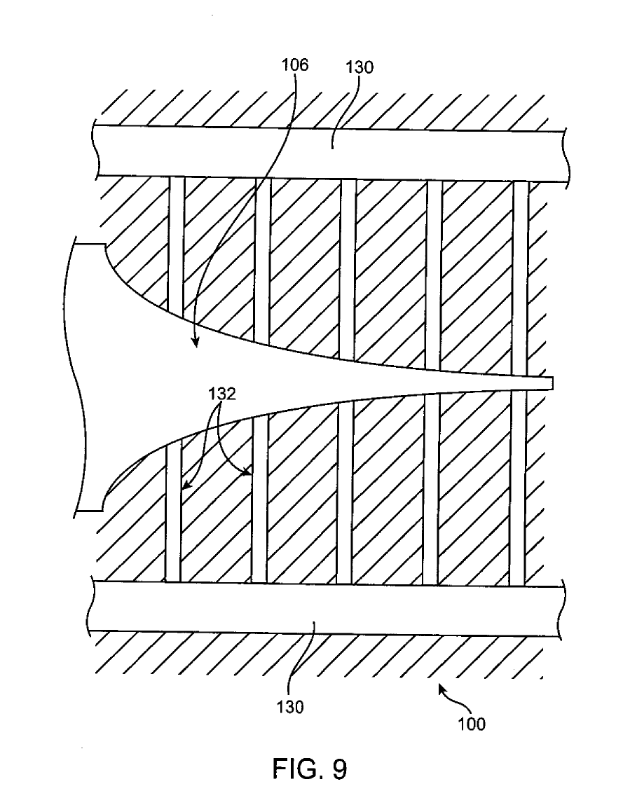

FIG. 9 is a cross-sectional view corresponding to FIG. 8. This embodiment of the invention may optionally be formed into an integral block of material, such as polydimethylsiloxane (PDMS). Like numerals refer to like elements.

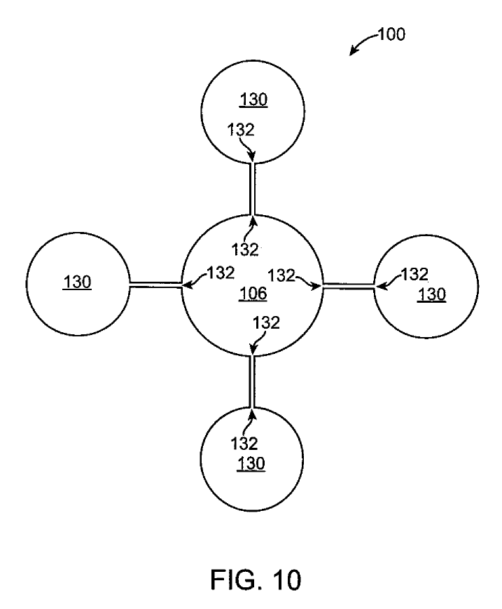

Lastly, FIG. 10 is a sectional elevation view of an embodiment of the invention similar to FIGS. 8 and 9, but having four supply channels. This embodiment of the invention may optionally be formed into an integral block of material, such as polydimethylsiloxane (PDSM).

As seen in FIGS. 8 and 10, the present invention comprises embodiments having any number of supply channels 132 attached thereto. An advantage of this design is that the same (or different) substances may be passed through the separate supply channels. When different substances are passed through different supply channels 132, different gradients may be created simultaneously along the length of the flow path through tapering flow channel 106.

In various embodiments, the substance passing through along through the at least one supply channel 132 may be: a fluid comprising a buffer, a fluid comprising an ionic solution, or a gas.

What is claimed:

1. A system for producing fibers, comprising:
a reservoir;
a tapering flow channel extending away from the reservoir;
a coating injector disposed between the reservoir and a proximal end of the tapering flow channel;
a gradient generator connected to the tapering flow channel;
a fluid outlet at a distal end of the tapering flow channel; and
a fiber outlet at the distal end of the tapering flow channel.

2. The system of claim 1, wherein the coating injector is configured to inject a lipid lubricating layer that decreases shear in a solution passing out of the reservoir.

3. The system of claim 1, wherein the coating injector is disposed to inject coating into the flow path from the reservoir into the tapering flow channel.

4. The system of claim 1, wherein the gradient generator generates an increasing gradient of potassium ions along the flow path.

5. The system of claim 1, wherein the gradient generator generates a decreasing gradient of sodium ions along the flow path.

6. The system of claim 1, wherein the gradient generator generates a decreasing pH gradient along the flow path.

7. The system of claim 1, wherein the system is formed into a unitary block of material.

8. The system of claim 7, wherein the unitary block of material is PDMS.

9. The system of claim 1, wherein the tapered channel is cylindrical.

10. The system of claim 1, further comprising:
a fiber diameter adjustment valve positioned at the fiber outlet.

11. A method of producing fibers, comprising:
forming protein droplets in a reservoir;
forming a coating on a stream of the protein droplets by introducing a coating as a laminar sheath flow;
passing the coated protein droplets through a tapered flow path while varying the chemical gradient along the tapered flow path so as to initiate polymerization and cause shear-induced polymerization and outward diffusion of solvent, thereby forming a fiber;
removing fluid at a distal end of the tapering flow channel; and thereby
producing fiber at the distal end of the tapering flow channel.

12. The method of claim 11, wherein the reservoir is a water bath.

13. The method of claim 11, wherein the coating is a lipid coating.

14. A system for producing fibers, comprising:
a reservoir;
a tapering flow channel extending away from the reservoir;
at least one supply channel; and
a series of feeder channels connecting the at least one supply channel to the tapering flow channel, wherein the series of feeder channels are dimensioned to generate a gradient in a fluid passing along through the length of the tapering flow channel.

15. The system of claim 14, wherein the series of feeder channels are dimensioned such that particle movement from the at least one supply channel to the tapering flow channel is dominated by diffusion effects rather than by convection effects.

16. The system of claim 14, wherein the at least one supply channel and the series of feeder channels are dimensioned such that fluidic resistance in the series of feeder channels is at least an order of magnitude higher than fluidic resistance in the at least one supply channel.

17. The system of claim 14, wherein the tapering flow channel and the series of feeder channels are dimensioned such that fluidic resistance in the series of feeder channels is at least an order of magnitude higher than fluidic resistance in the tapering flow channel.

18. The system of claim 14, further comprising the fluid passing along through the length of the tapering flow channel.

19. The system of claim 18, wherein the fluid passing along through the length of the tapering flow channel comprises a protein polymer stream.

20. The system of claim 14, further comprising a substance passing through along through the at least one supply channel.

21. The system of claim 20, wherein the substance passing through along through the at least one supply channel comprises at least one of:
a fluid comprising a buffer, a fluid comprising an ionic solution, or a gas.

22. The system of claim 14, wherein the at least one supply channel comprises a pair of supply channels having the same substance passing therethrough.

23. The system of claim 14, wherein the at least one supply channel comprises a pair of supply channels having different substances passing therethrough.

24. The system of claim 14, wherein the tapered flow channel is shaped as a hyperbolically converging tube.

25. The system of claim 14, wherein the tapered flow channel comprises a fiber outlet having a diameter from 1 micrometer to 10 millimeters.

26. The system of claim 14, wherein the system is formed into a unitary block of material.

27. The system of claim 26, wherein the unitary block of material is PDMS.

28. A method of producing fibers, comprising:
passing a polymer flow through a tapering flow channel;
passing a substance through at least one supply channel, wherein the at least one supply channel is connected to the tapering flow channel by a series of feeder channels dimensioned to generate a gradient in a fluid passing along through the length of the tapering flow channel such that the polymer flow becomes polymerized by shear and/or elongation induced polymerization, thereby forming a fiber.
